(19) United States
(12) Patent Application Publication
(10) Pub. No.: US 2014/0351283 A1
(43) Pub. Date: Nov. 27, 2014

(54) WEB-BASED SEARCH TOOL FOR PROCESSING RELEVANT INFORMATION

(71) Applicant: TECHNOLOGIES iTRADEMARK, Montreal (CA)

(72) Inventors: France Côté, Saint-Sauveur (CA); Alexandra Gariépy, Saint-Sauveur (CA)

(21) Appl. No.: 14/344,456

(22) PCT Filed: Sep. 12, 2012
(86) PCT No.: PCT/CA2012/000821

§ 371 Date: Aug. 15, 2014

Related U.S. Application Data
(60) Provisional application No. 61/533,563, filed on Sep. 12, 2011.

(51) Int. Cl. G06F 17/30

(52) U.S. Cl. CPC G06F 17/30864; G06F 17/30241
USPC 707/770

(57) ABSTRACT

The present document describes a web-based search tool for processing relevant information, the web-based search tool comprising: a user interface for allowing a user to connect to the web-based search tool and to enter relevant information; a network communication device for giving access to a member database on which a plurality of members are registered; a processor having access to the user interface and the network communication device; and a memory operatively coupled to the processor for storing instructions to be performed by the processor, the instructions cause the processor to: one of: process the relevant information entered by the user; and inform one of the plurality of members of the relevant information entered by the user.

### BACKGROUND

(a) Field

The subject matter disclosed generally relates to a web-based search tool for processing relevant information. More particularly, the subject matter disclosed relates to a web-based search tool for proposing a list of potential suppliers and for processing relevant information.

(b) Related Prior Art

For several years, many companies and organizations have opted for creation of web-based tools (application, web sites and the like) to showcase their services to their clients. Although the creation, preparation and marketing of these web-based tools represent important expenses, rate of return for these companies and organizations is of significant importance. Companies and organizations of all kinds are often able to get new clients, especially young and dynamic clients who adopt such web-based tools. For example, law firms, intellectual property firms, accountant firms, as well as all organizations with professionals who want to increase their business could benefit from such web-based tools.

Indeed, today and in recent decades, it is well known that intellectual property firms, which hire lawyers, patent and trademark attorneys, work with international clients. Intellectual property firms do business with local clients, which represent clients who reside in the same country as the firm, but also with correspondents patent and trademark attorneys, who correspond to attorneys who pursue the same profession as they do, but in other countries such as, without limitation, Japan, France, Germany and the like. In this sense, since patent or trademark attorneys can file patents and trademarks for clients usually residing only in their country, patent or trademark attorneys must deal with other attorneys (i.e.: Japan, France, Germany), which help them in filing and prosecuting patents and trademarks applications in other countries and under their jurisdiction.

In order for law firms, but especially intellectual property firms, to generate the maximum revenue, it is essential that the firms always keep looking for new business, new clients, which in turn, will generate non negligible income. Therefore, there is a need for a web-based search tool that allows a law firm or an intellectual property firm to generate the maximum revenue in finding new clients who wish to file patent applications and/or trademark applications.

There are already several web-based search tools held by firms or intellectual property firms, which allow a user to search the availability of a trademark. However, such web-based search tools do not allow a user who finds that his trademark is available (or his invention patentable), to contact in real time a trademark attorney (or a patent attorney), which would be located at a specific geographical location. Indeed, such known web-based search tools do not allow a user to directly file his application via a trademark attorney or a patent attorney or by himself.

Therefore, there is a need for a web-based search tool for processing relevant information. More particularly, there is a need for a web-based search tool for proposing a list of potential suppliers based on their geographical location, the potential suppliers being, for example, trademark attorneys and/or patent attorneys.

### SUMMARY

According to an embodiment, there is provided a web-based search tool for processing relevant information, the web-based search tool comprising: a user interface for allowing a user to connect to the web-based search tool and to enter relevant information; a network communication device for giving access to a member database on which a plurality of members are registered; a processor having access to the user interface and the network communication device; and a memory operatively coupled to the processor for storing instructions to be performed by the processor, the instructions cause the processor to: one of: process the relevant information entered by the user; and inform one of the plurality of members of the relevant information entered by the user.

According to another embodiment, process the relevant information entered by the user is processed by an intermediary actor.

According to another embodiment, process the relevant information entered by the user comprises seek the relevant information entered by the user on a database including or not the relevant information prior to processed the relevant information.

According to another embodiment, inform one of the plurality of members comprises identify a member prior to inform one of the plurality of members.

According to another embodiment, the instructions causes the processor to further transmit relevant information sought or entered by the user to the informed member.

According to another embodiment, the plurality of members are professionally qualified to provide services according to the relevant information entered by the user.

According to another embodiment, each one of the plurality of members are registered in the member database.

According to another embodiment, the web-based search tool further comprising a geographical position locator for obtaining a geographical position of at least one of: one or plurality of the plurality of members and the user.

According to another embodiment, each one of the plurality of members is being registered in the member database in association with a corresponding geographical position thereby defining a plurality of member geographical positions.

According to another embodiment, identify a member comprises identify a member based on the plurality of geographical positions of the plurality of members.

According to another embodiment, the plurality of members comprise lawyers, patent attorneys, accountants, publicists, engineers, trademark attorneys, professionals, law firms, accountant firms, trademark firms, patent firms, intellectual property firms, professional firms, engineering firms, estate agents and any combination thereof.

According to another embodiment, the geographical position locator is in communication with at least one of: a global positioning system, a position entry prompt and any suitable combination.

According to another embodiment, the geographical position comprises geographical coordinates, a country, a continent, a city, a street, a complete address, a state and any suitable combination.

According to another embodiment, the database comprises one of: a public database, a private database and any suitable combination.

According to another embodiment, the public database comprises a CIPO database, a USPTO database, an OHIM database, a WIPO database, a National Bureau of Patents and trademarks database and any suitable combination.

According to another embodiment, the relevant information comprises a trademark, invention patent, a company name and information, design data for industrial equipments, design data for structures or buildings and any suitable combination.

According to another embodiment, processing the relevant information comprises seeking the availability of a trademark, seeking the patentability of an invention, filing a trademark application, filing a patent application, seeking the availability for registration of a company, processing design data for industrial equipments, processing design data for structures or buildings and any suitable combination.

According to another embodiment, the member database further comprises information for each one of the plurality of members.

According to another embodiment, the information for each one of the plurality of members comprises a name, a first name, a firm or organization to which the member belongs, a logo of the firm or organization to which the member belongs, a personal photo, a biography, expertise information, areas of practice information, education information, an email address, a telephone number, an address of the firm to which the member belongs, a video of the firm or organization to which the member belongs and any suitable combination.

According to another embodiment, identify a member based on the geographical position of the member further comprises calculate distances between the geographical position of the user and each one of the geographical positions of the plurality of members and determine the smallest one of the distances.

According to another embodiment, identify a member based on the geographical position of the member further comprises using the smallest one of the distances and identify which one of the plurality of members is closest to the geographical position of the user.

According to another embodiment there is provided a web-based search tool for processing relevant information, the web-based search tool configured to perform the steps of: process relevant information entered by a user; and inform one of a plurality of members of the relevant information entered by the user.

According to another embodiment, the web-based search tool further comprises the step of seeking the relevant information entered by the user on a database including the relevant information sought or not prior to process the relevant information entered by the user.

According to another embodiment, the web-based search tool further comprises the step of identify a member from the plurality of members prior to inform one of the plurality of members.

According to another embodiment, the web-based search tool further comprises the step of transmit relevant information sought or entered by the user to the informed member

According to another embodiment, the web-based search tool is further configured to perform the step of obtaining a geographical position from a geographical position locator for the plurality of members of the web-based search tool and for a user of the web-based search tool.

According to another embodiment, identify the member from the plurality of members comprises identify the member from the plurality of members based on the geographical positions of the plurality of members.

According to another embodiment, identify the member based on the geographical position of the member further comprises calculate distances between the geographical position of the user and each one of the geographical position of the plurality of members and determine the smallest one of the distances.

According to another embodiment, identify the member based on the geographical position of the member further comprises using the smallest one of the distances and identify which one of the plurality of members is closest to the geographical position of the user.

According to an embodiment, there is provided a web-based search tool for filing out an order for a product or a service for which members are qualified to provide, the web-based search tool comprising:—a user interface for allowing a user:—to enter a query comprising information related to the order of the product or the service, namely relevant information; and—to enter identification information about the user;—a network communication device for giving access to a member database on which the members are registered;—a processor having access to the user interface and the network communication device; and—a memory operatively coupled to the processor for storing instructions to be performed by the processor, the instructions cause the processor to perform at least one of:—execute the order comprising the relevant information entered by the user; and—inform one of the plurality of members of the query and identification information about the user.

According to another embodiment, the user interface allowing a user to enter a query further comprises allowing a user to enter form-related information defining the specification of the product or the service.

According to an embodiment, there is provided a web-based search system for processing an order for a product or a service for which members are qualified to provide, the client system comprising:

a user interface for receiving a search query to inquire about the availability of the product or service on a given territory;

a search server for receiving the query and for determining the availability of the product or service on the given territory; and

a member server also for receiving the query and for returning a list of members qualified to provide the product or service on the given territory.

According to another embodiment, the web-based search system further comprises a geographical position locator for obtaining a geographical position of the user interface.

According to another embodiment, the member server is for returning the list of members ordered according to the geographical proximity to the user interface.

According to another embodiment, the user interface is further for receiving client identification information and wherein the member server is also for receiving the client identification information.

According to an embodiment, there is provided a web-based search system for processing an order for a product or a service for which members are qualified to provide, the client system comprising:

a user interface for allowing a user to enter form-related information defining the specification of the product or the service;

a geographical position locator for obtaining a geographical position of the user interface;

a member server for receiving the form related information, for returning a list of members qualified to provide the product or service on the given territory according to proximity with the user interface and, based on a selection of at least one of the members according to a proximity with the user interface, processing the form-related information to produce a proposal including at least one of price for the product or the service and a submission for the deliverable comprising a description corresponding to the specification of the product or the service and for returning the proposal to the user interface.

The following terms are defined below.

The term “relevant information” is intended to include, without limitation, information related to services or products provided by a potential supplier. The relevant information may also be intended to mean the information that can be processed by a professional of any field. The relevant information may include, without limitations, a trademark, a patent application, a company name and/or information, design data for industrial equipments, design data for structures or buildings, renovation parameters (stairs, kitchen, lights installation) and the like.

The expression “processing relevant information” is intended to include, without limitation, a professional task or step to be performed by a professional of any field. The expression “processing relevant information” may also be intended to mean processing information related to services or products by a potential supplier. Processing the relevant information may comprise seeking the availability of a trademark (by a trade mark attorney/trademark agent), seeking the patentability of an invention (by a patent attorney/patent agent), filing a trademark application (by a trademark attorney/trademark agent/or directly online), filing a patent application (by a patent attorney/patent agent or directly online), seeking the availability for registration of a company (by a lawyer for example), processing design data for industrial equipments (by an engineer for example), processing design data for structures or buildings (by a structural engineer for example). Finally, processing relevant information may also include processing the information by a server automatically without human intervention; e.g., performing a search in a database, outputting information on pricing from a database, outputting pro-forma designs based on standardized information (form-related information) supplied by a user, etc.

The term “member” is intended to include, without limitation, anyone who wants to be part of a directory of suppliers or of a directory of professionals that would be accessible to users of the web-based search tool. Members may be, without limitations, lawyers, patent attorneys, accountants, publicists, engineers, trademark attorneys, professionals, law firms, accountant firms, trademark firms, patent firms, intellectual property firms, professional firms, engineering firms, estate agents, any suitable combination and any organization or companies of professionals interested in seeing increasing significantly their business.

The term “user” is intended to include, without limitation, anyone using the web-based search tool looking for specific and relevant information related to a particular profession. A user of the web-based tool may be seeking for relevant information and/or may want to process directly relevant information by himself. For example, the user may want to seek the availability of a trademark in Canada (seeking its relevant information) and/or may want to file directly the trademark (if available if a search has been make prior filing) in Canada (process the relevant information).

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1A illustrates schematically a web-based search tool in accordance with an embodiment;

FIG. 1B illustrates the steps performed by the web-based search tool in accordance with another embodiment;

FIG. 2 illustrates a screenshot taken from the web-based search tool in accordance with another embodiment;

FIG. 2A illustrates a screenshot taken from the web-based search tool in accordance with another embodiment;

FIG. 2B illustrates a screenshot taken from the web-based search tool in accordance with another embodiment;

FIG. 2C illustrates a screenshot taken from the web-based search tool in accordance with another embodiment;

FIG. 2D illustrates a screenshot taken from the web-based search tool in accordance with another embodiment;

FIG. 2E illustrates a screenshot taken from the web-based search tool in accordance with another embodiment;

FIG. 2F illustrates a screenshot taken from the web-based search tool in accordance with another embodiment;

FIG. 2G illustrates a screenshot taken from the web-based search tool in accordance with another embodiment;

FIG. 2H illustrates a screenshot taken from the web-based search tool in accordance with another embodiment;

FIG. 2I illustrates a screenshot taken from the web-based search tool in accordance with another embodiment;

FIG. 2J illustrates a screenshot taken from the web-based search tool in accordance with another embodiment;

FIG. 2K illustrates a screenshot taken from the web-based search tool in accordance with another embodiment;

FIG. 2L illustrates a screenshot taken from the web-based search tool in accordance with another embodiment; and

FIG. 2M illustrates a screenshot taken from the web-based search tool in accordance with another embodiment.

It will be noted that throughout the appended drawings, like features are identified by like reference numerals.

### DETAILED DESCRIPTION OF THE PREFERRED EMBODIMENTS

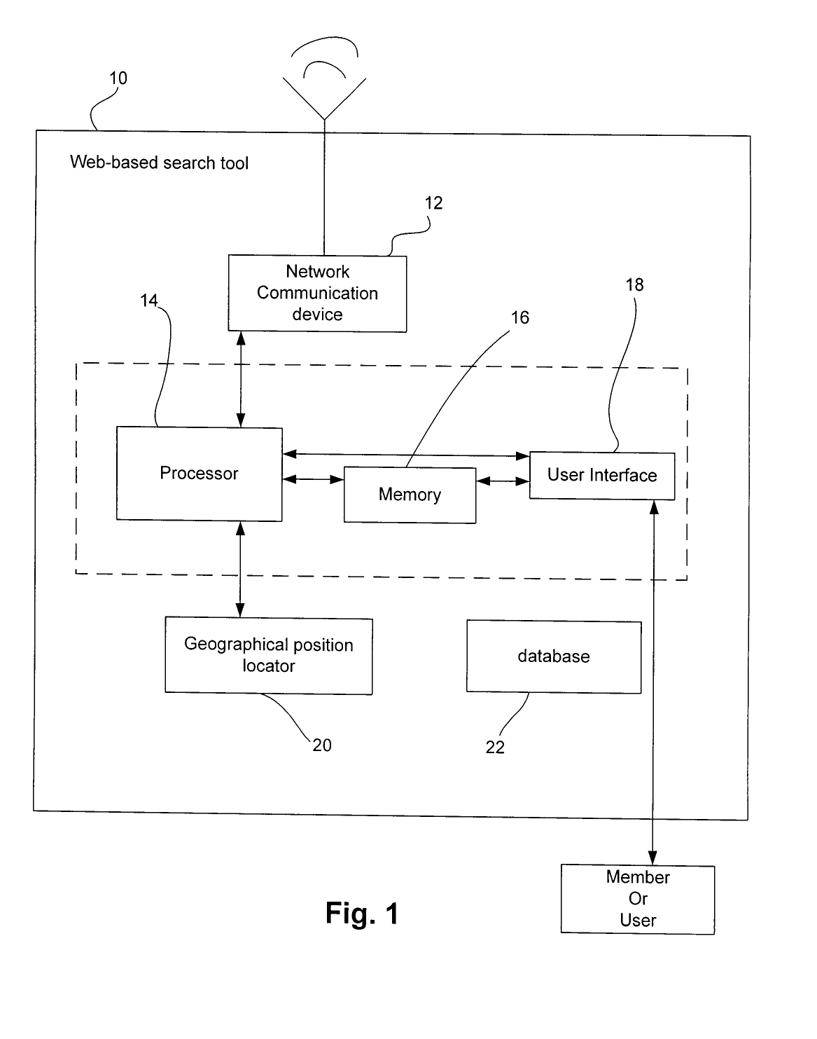

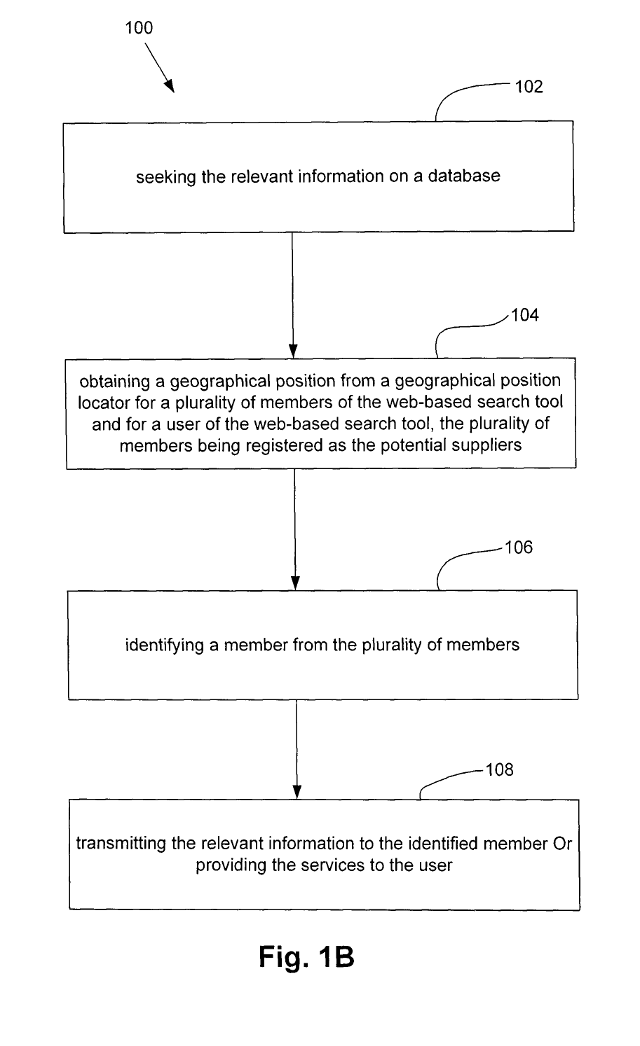

Referring now to the drawings, and more specifically to FIG. 1, there is shown a web-based search tool 10 which can be utilized by a user, a member, or a new member. The web-based search tool 10 may be for proposing a list of potential members (also referred to as suppliers), for providing a service by a member to a user and/or to allow a user to process relevant information. The web-based search tool 10 includes a user interface 18 for allowing a member, a new member or a user to connect to the web-based search tool 10. The web-based search tool 10 may optionally include a geographical position locator 20 for obtaining a geographical position of the member and the user and a network communication device 12 for giving access to a database 22. It is to be noted that the database 22 may include the relevant information or may not include the relevant information sought by the user. The network communication device 12 further gives access to a member database on which a plurality of members may be registered as the potential suppliers. The plurality of members may be qualified to provide services in relation to the relevant information sought or processed by a user and each one of the plurality of members may be registered in the member database in association with a corresponding member geographical position for defining a plurality of member geographical positions. The web-based search tool 10 may further include a processor 14 having access to the user interface 18 and the network communication device 12 and a memory 16 operatively coupled to the processor 14 for storing instructions to be performed by the processor 14. The instructions cause the processor 14 to process the relevant information.

According to another embodiment, process the relevant information entered by the user may be processed by an intermediary actor.

According to another embodiment, the instructions may cause de processor 14 to at least one of: seek the relevant information, identify a member, transmit the relevant information sought by the user or not sought by the user to the identified member and inform a member that he needs to provide services to a user.

According to another embodiment, the web-based search tool 10 may further include an optional geographical position locator 20 for obtaining a geographical position of at least one of: the member and the user.

According to another embodiment, each one of the plurality of members may be registered in the member database in association with a corresponding geographical position for defining a plurality of member geographical positions.

According to another embodiment, it is to be noted that provide the services to the user may include provide the services to the user in relation to the relevant information sought and that identify a member may include identify a member based on the plurality of geographical positions of the members.

According to another embodiment, the members of the web-based search tool 10 may include lawyers, patent attorneys, accountants, publicists, engineers, trademark attorneys, professionals, law firms, accountant firms, trademark firms, patent firms, intellectual property firms, professional firms, engineering firms, estate agents, any suitable combinations and the like.

According to another embodiment, there is provided a geographical position locator 20 which may be in communication with at least one of, without limitation, a global positioning system, a position entry prompt, any suitable combination and the like. Moreover, the geographical position may include information regarding geographical coordinates, a country, a continent, a city, a street, a complete address, a state, any suitable combination and the like.

According to another embodiment, the database 22 may optionally include a public database, a private database and any suitable combination. For example, the public database may include a CIPO database, a USPTO database, an OHIM database, a WIPO database, a National Bureau of Patents and trademarks database and any suitable combination. On the other hand, the private database may include for example, LexisNexis TotalPatent™ database or any other suitable database.

According to another embodiment, the relevant information may include, without limitation, availability of a trademark, patentability of an invention, availability for registration of a company, design data for industrial equipments, design data for structures or buildings and any suitable combination and the like.

According to another embodiment, the member database may further include information for each one of the members. On the other hand, the information for each one of the members may include a name, a first name, a firm or organization to which the member belongs, a logo of the firm or organization to which the member belongs, a personal photo, a biography, expertise information, areas of practice information, education information, an email address, a telephone number, an address of the firm to which the member belongs, a video of the firm or organization to which the member belongs, any suitable combination and the like.

According to another embodiment, the services in relation to the relevant information may include filing a trademark, filing a patent application, filing a design application, incorporating a new company, designing industrial equipment, designing a structure or a building, buying a house, providing legal services, providing legal information, any suitable combination and the like.

According to another embodiment, identify a member based on the geographical position of the member may further includes calculate distances between the geographical position of the user and each one of the geographical positions of the plurality of members and determine the smallest one of the distances. Moreover, identify a member based on the geographical position of the member may further includes using the smallest one of the distances and identify which one of the plurality of members is closest to the geographical position of the user. Additionally, transmit the relevant information sought by or to be processed by the user to the identified member for providing the services to the user in relation to the relevant information sought may further includes display, on the user interface 18, contact information for the member closest to the current position thereby enabling the user to contact the member displayed on the user interface 18.

According to another embodiment, there is provided the web-based search tool 10 of FIG. 1 for proposing a list of potential members or suppliers having been qualified to provide services and/or for processing relevant information sought or entered by the user and where the web-based search tool 10 is configured to perform steps, as shown in FIG. 1B. The web-based search tool 10 may be configured to perform the step 102 of seeking relevant information entered by a user on a database 22. The web-based search tool 10 may also be configured to perform the step 106 of identifying a member or processing the relevant information sought or not by the user and the step 108 of at least one of: transmitting the relevant information to the identified member and provide the services to the user.

According to another embodiment, the web-based search tool may further be configured to perform the step 104 of obtaining a geographical position from a geographical position locator 20 for a plurality of members of the web-based search tool 10 and for a user of the web-based search tool 10, where the plurality of members may be registered as the potential suppliers.

According to another embodiment, there is also provided a web-based search tool 10 for proposing a list of potential suppliers having been qualified to provide services in relation to relevant information or directly processing relevant information entered by a user. The web-based search tool 10 is configured to perform a method including the step of seeking the relevant information on a database 22, where the database 22 includes relevant information or capturing relevant information entered by a user. The method may also include the step of obtaining a geographical position from a geographical position locator 20 for a plurality of members of the web-based search tool 10 and for a user of the web-based search tool 10, where the plurality of members may be registered as the potential suppliers. The method may also include the step of accessing a member database on which members are registered as the potential suppliers, where the members may be qualified to provide services in relation to the relevant information and where the members may be registered in the member database in association with a member geographical position for defining a plurality of member geographical positions. It is to be noted that the member database may also includes contact information for each one of the members. The method may also include the step of identifying a member from the plurality of members based on the geographical positions of the plurality of members and the step of transmitting the relevant information sought or not by a user to the identified member for providing the services in relation to the relevant information sought to the user. It is to be noted that the steps may be performed consecutively or not. It is also to be noted that the user may decide to process his relevant information directly, without seeking the availability on a database of the relevant information and without contacting a member from the member database prior to process its relevant information.

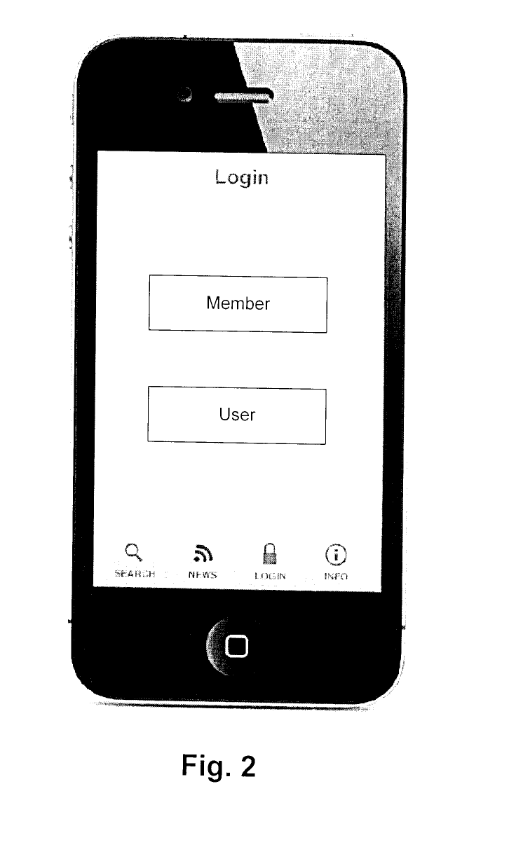

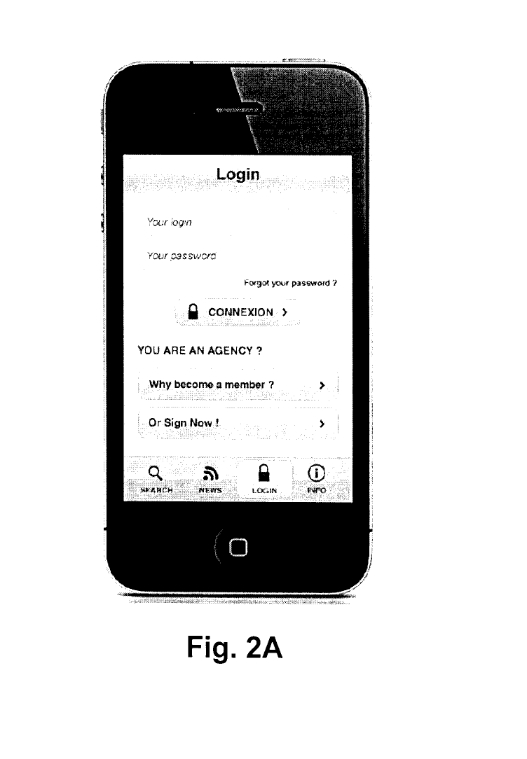

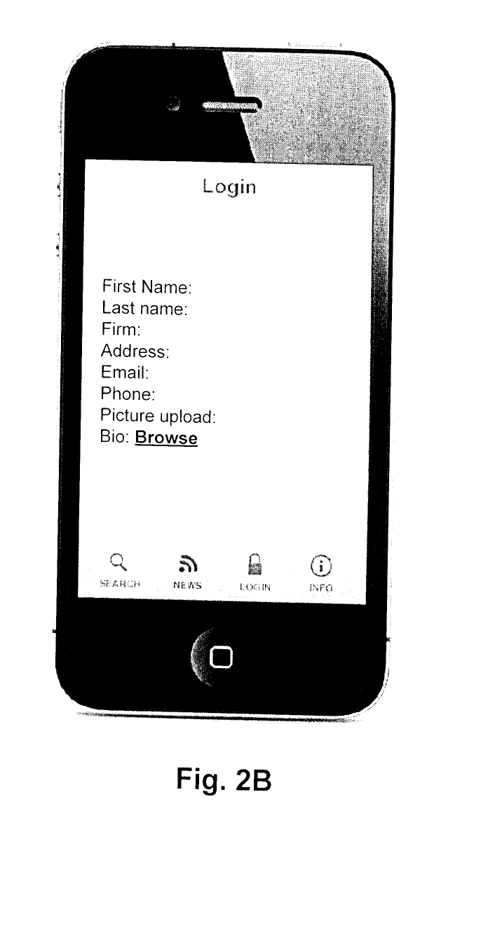

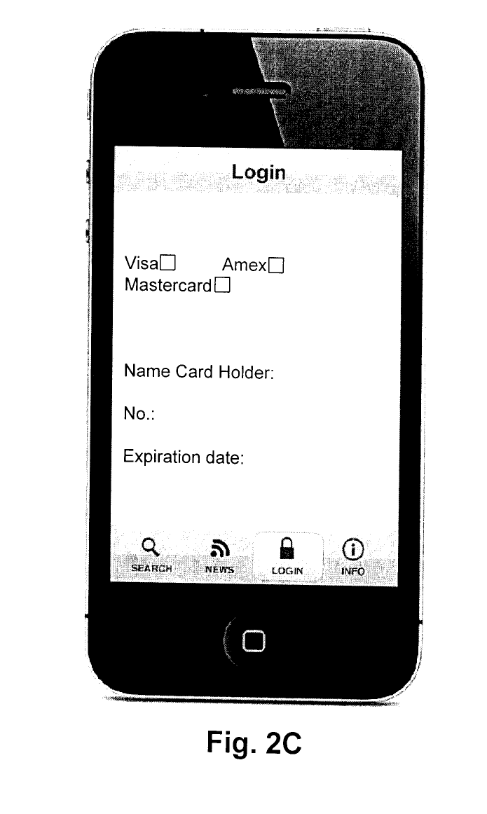

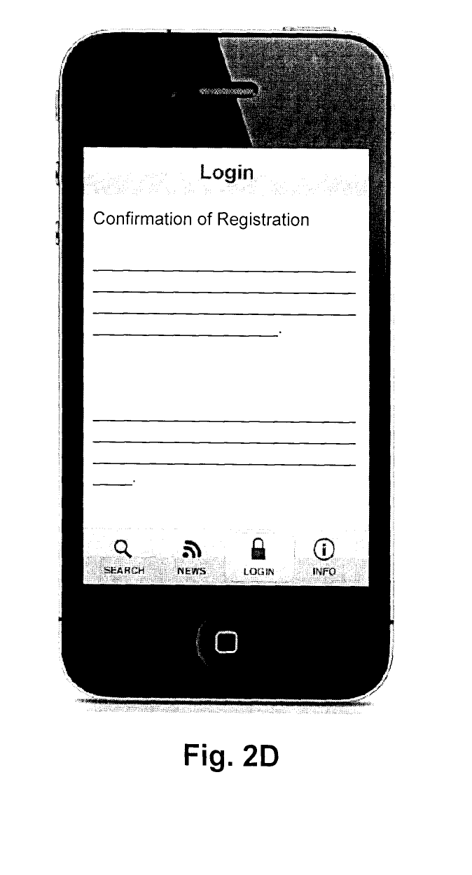

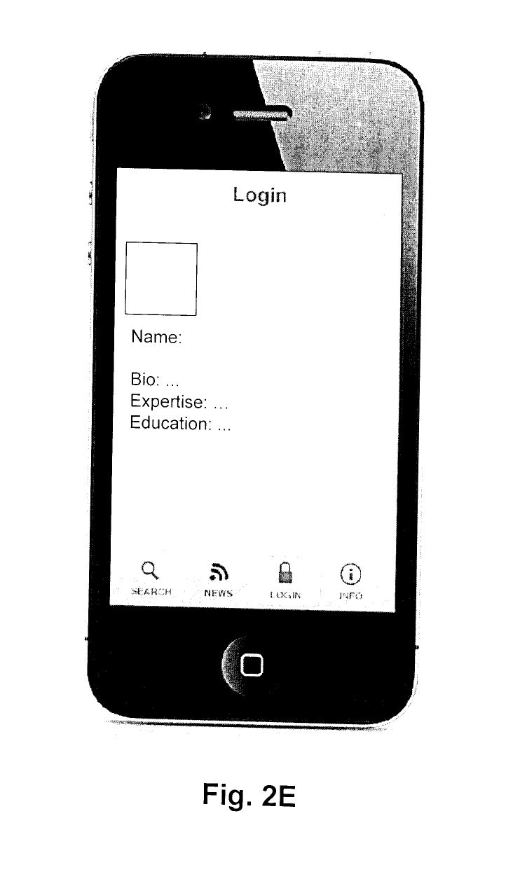

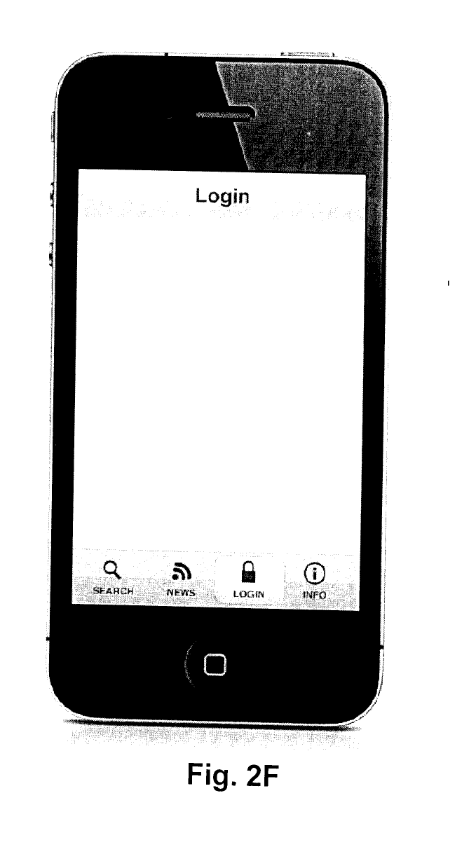

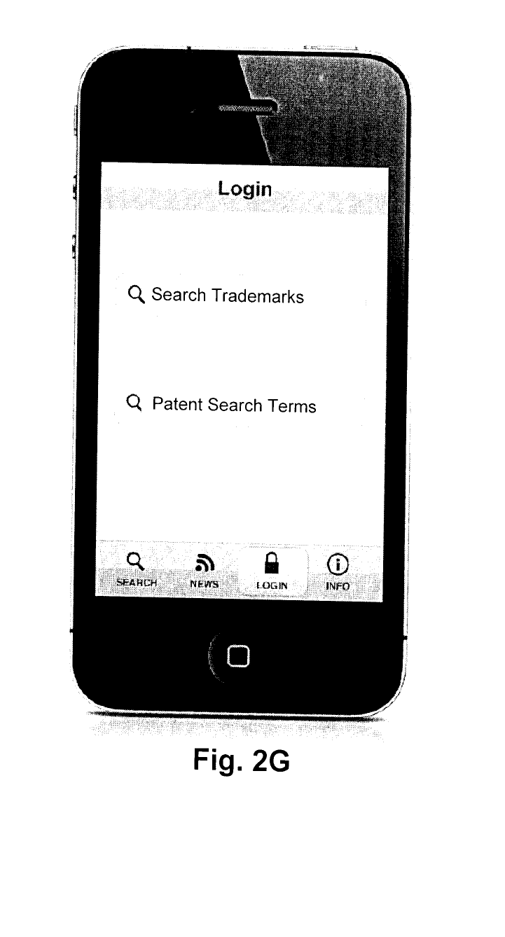

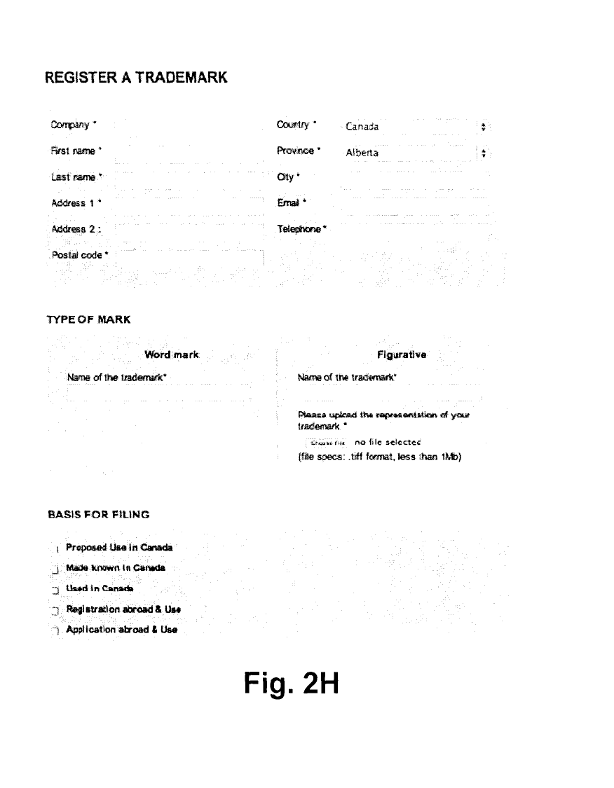

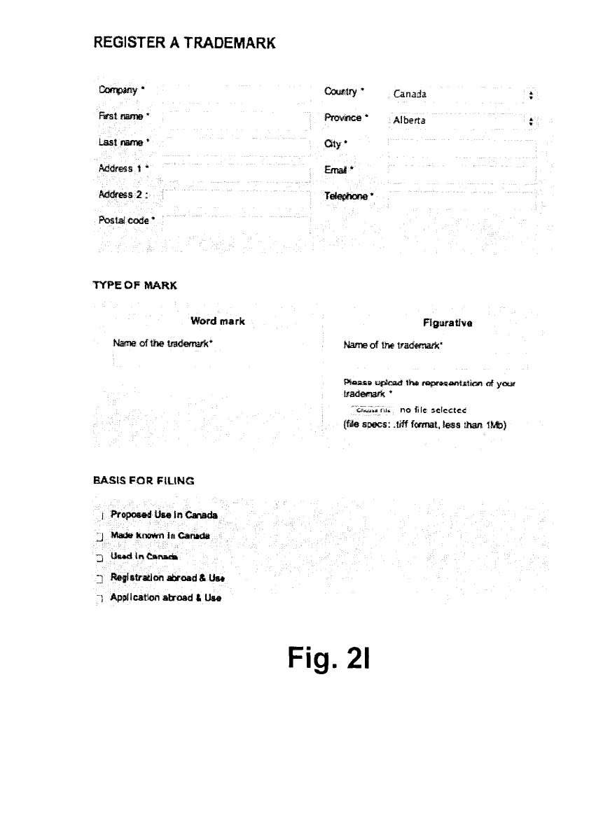

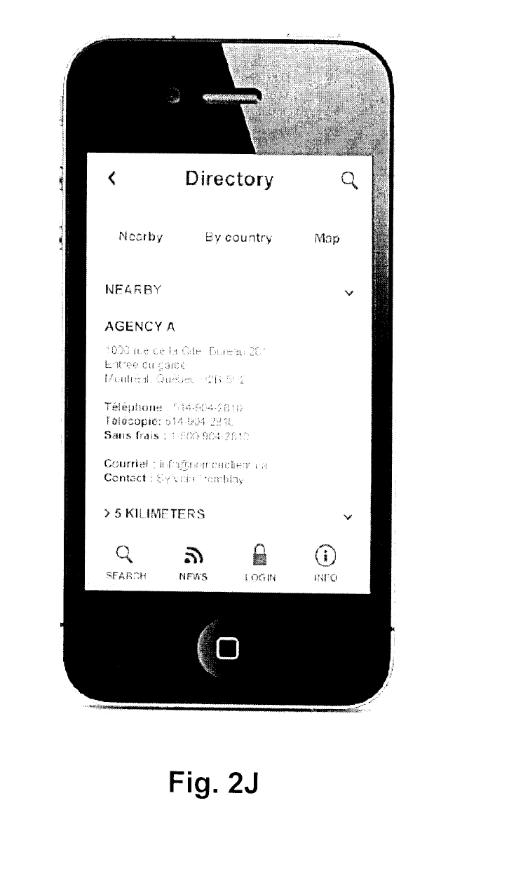

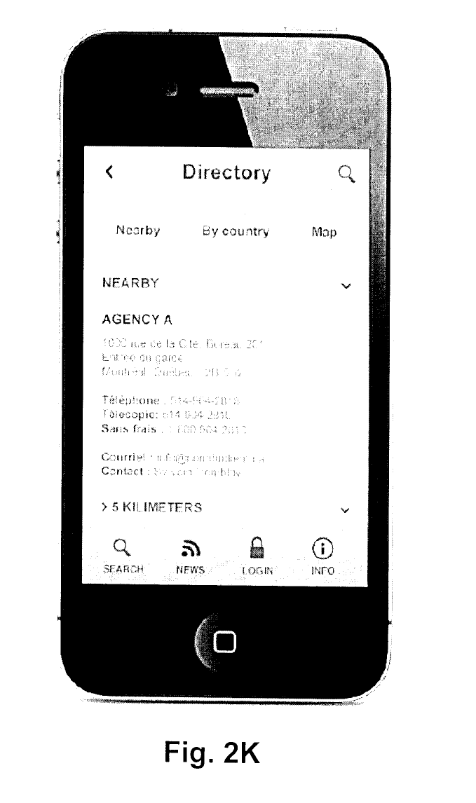

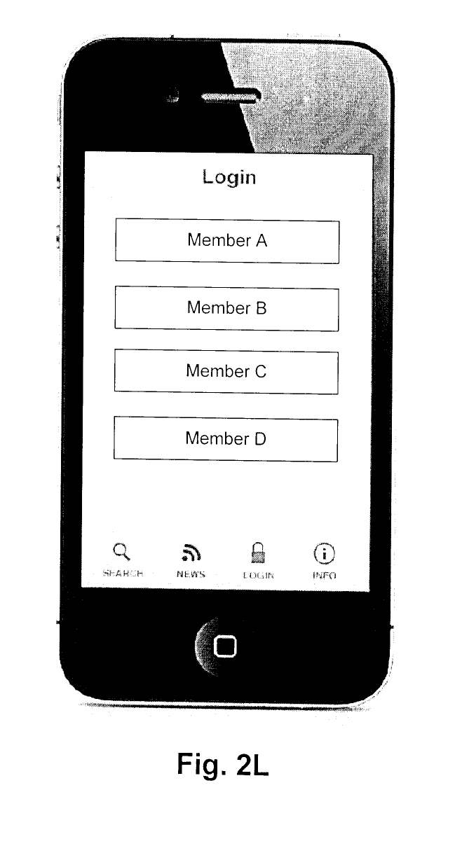

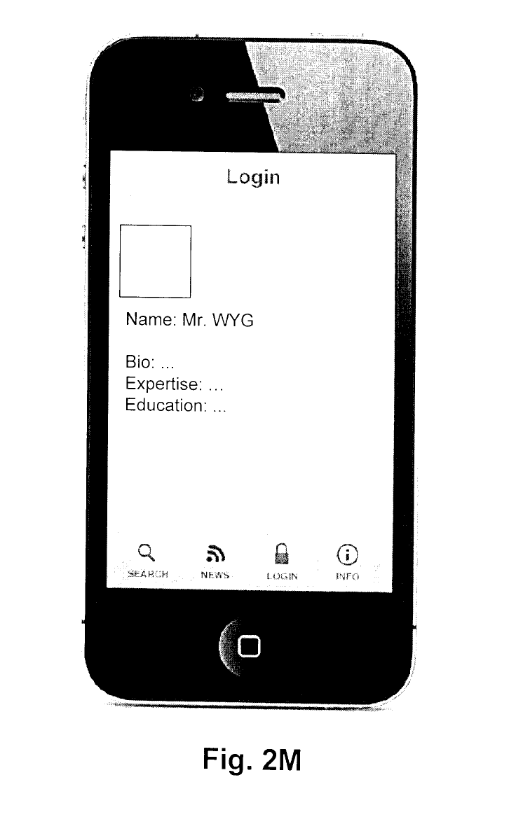

Also, FIG. 2 to FIG. 2M illustrate screenshots taken from a web-based search tool 10 in accordance with different embodiments and more particularly to screenshots taken from a web-based search tool 10 proposing a list of potential trademark attorneys or trademark firms based on their geographical location or for directly filing a trademark or a patent application. More specifically, FIG. 2 illustrates a screenshot taken from the web-based search tool 10 where the user has just opened the web-based search tool 10. It is important to note that the user can use this web-based search tool 10 with a smart phone, but also with a numeric tablet, or a normal computer access to a communication network (i.e.: Mobile website, all mobile platforms, Traditional website, multiple OS, browsers, iPhone Application via itunes, etc.). The smart phone can be, without limitations, an iPhone device, a BlackBerry device, an Android device, a Windows device, and the like. On the other hand, the numeric tablet can be, for instance and without limitations, an iPad device, a Blackberry Playbook device, a Motorola Xoom device and the like. Moreover, in FIG. 2, the user may select, using the interface of the web-based search tool 10 if he wants to enter as a member (trademark attorney or trademark firm), or as a user (user seeking for the availability of a trademark). The user may also decide, at this stage, if he wants to directly file his trademark or patent information, without seeking for the availability of his trademark or for the novelty of his invention prior to process the relevant information.

Initially, if the user chooses to navigate in the web-based search tool 10 as a member, it will show, for example, a screenshot as the screenshot illustrated in FIG. 2A. Indeed, if the user chooses to travel the web-based search tool 10 as a member, it will show, for example, a screenshot as the screenshot illustrated in FIG. 2A, which will determine if the member is a new member or if the member is already in the member database of the web-based search tool 10.

FIG. 2B illustrates an example of a possible screenshot for a new member wishing to join the member database and that needs to enter his contact information. For example, the new member will need to download contact information such as, without limitations, his name, first name, firm or organization to which the member belongs, the logo of the firm or organization to which the member belongs, his personal photo, biography, information on its expertise, areas of practice, education, email address, telephone number, address of the firm, his price or the price of his firm and the like. The new member may also be asked whether or not he wishes to receive future news and new information regarding the web-based search tool 10. It is important to mention that the new member may need to download some data for his registration to be possible (name, email address, etc.), while other information may be optional (photo, expertise, etc.).

Then, once the new member has entered all the information needed for him to become a member, the new member will be directed to a payment standard page. It is important to mention that to become a member, a specific fee will be charged. It is also possible that promotional rates may be offered to new members or to member who choose smaller territory such as a state instead of a country. For example, a firm interested in recording more than six new members at the same time may receive a special rate. It is also possible for a trademark attorney, a patent attorney, or a trademark and/or patent firm, by paying an additional fee, to have a monopoly in the country of interest. Indeed the member having monopoly in a country will be the only member capable of filing a trademark application in this specific country (or region) or the only member who will receive the relevant information directly filed by a user via the interface.

The screenshot for the payment of FIG. 2C includes the credit card information of the member, such as the number of the credit card, the expiration date of the credit card, holder's name of the credit card, the type of credit card (Visa, MasterCard, Amex, etc.) and the like.

Then, the screenshot shown schematically in FIG. 2D illustrates that the new member has now become a member and a confirmation may be sent by email.

On the other hand, when the user of the web-based search tool 10 sees the screenshot illustrated in FIG. 2A, he can already enter his username and password since he is already a member. It may show, for example, the screenshot illustrated in FIG. 2E, and the member may be able to modify and/or update the information entered previously. The member can, for example, change his name, first name, firm or organization to which the member belongs, the logo of the firm or organization to which the belongs, his personal photo, biography, information on his expertise, areas of practice, education, email address, telephone number, address of the firm, price or the price of his firm, and the like. It is also possible for members to delete their account permanently.

However, when the user of the application sees the screenshot illustrated in FIG. 2, he may choose to enter the web-based search tool 10 as a user. As shown in FIG. 2F, the user may decide to browse the components of research, frequently asked questions (FAQ's), news, contacts, and the like. Then, if the user wishes to start a search to seek for the availability of his trademark or the patentability of his invention, the user may select the search tab, which may appear as illustrated in FIG. 2G. For example, a search may be conducted to determine the availability of a trademark. The user will then select the component “trademark search”, and if the user wishes to determine the patentability of his invention instead, the user may select the component “patent search”. However, it is to be noted that, instead of seeking for the availability of a trademark, for instance, the user may decide to directly file a trademark application without consulting the trademark database of his country.

Indeed, by selecting the component “trademark search”, the user may see a screenshot as the screenshot illustrated in FIG. 2H. The user may then specify the name of the trademark he is looking for, and the country where he wants to do his search. Further information may be requested to the user, such as the specific class of the trademark, the scope of the invention, and the like.

Then, as shown in FIG. 2I, the user may be able to know if the trademark is available. Similarly, for patent searches, the user may be able to know if his invention, according to a search by keywords, would be patentable with respect to the novelty criteria. Again, it is to be noted that, instead of seeking for the availability of a trademark, for instance, the user may decide to directly file a trademark application without consulting the trademark database of his country. A question may be asked to the user as to know whether he wishes to contact a trademark or a patent attorney to discuss it further or he wishes to file his trademark application in real time. Indeed, it is possible for the user to select the option “file my trademark” as shown in FIG. 21, where the user may be able to complete an application form for its trademark which will be sent to a registered member, prior to be filed. In this specific case, it would be easy for a member to file the trademark application to a patent and trademark national office. Since the geographical position of the user may be known, the closest trademark attorney or patent attorney would be selected or the trademark/patent attorney that has paid additional fees (allowing him the monopoly on a specified territory) would be selected in this case.

The user may also be able to contact a selected attorney by email or by phone, as shown in FIG. 2J. It is also important to mention that the user may also choose to browse the registry of trademark attorney and patent attorneys, known as the members, of the respective countries. The user could read the biographies of various attorneys, and make a personal choice.

The web-based search tool 10 as described above provides a member to expand his client base by directory listing and cross-platform accessibility. Moreover, the web-based search tool 10 may increase the visibility of a member by allowing the member to create content and by facilitating the interaction with the user (basic registration information provided). The web-based search tool 10 may also increase profits for a user having more visibility, more clients, less administrative hassle and fast process of applications.

The web-based search tool 10 is an initiative to reaching out to a new generation of clients. The web-based search tool 10 may allow the user to perform a basic search for trademark availability in selected databases and prompts them to contact an agent.

The member database allows the user to look for a nearby member (using location services) or a member in a different country.

The web-based search tool 10 may also allow the user to fill out a customized filing form, pay applicable fees set by and sent directly a member. It also facilitate the user interaction since the member receives the filing information directly.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A web-based search tool for processing relevant information, the web-based search tool comprising:
a user interface for allowing a user to connect to the web-based search tool and to enter relevant information;
a network communication device for giving access to a member database on which a plurality of members are registered;
a processor having access to the user interface and the network communication device; and
a memory operatively coupled to the processor for storing instructions to be performed by the processor, the instructions cause the processor to:
one of:
process the relevant information entered by the user; and inform one of the plurality of members.

2. The web-based search tool of claim 1, wherein process the relevant information entered by the user is processed by an intermediary actor.

3. The web-based search tool of claim 1, wherein process the relevant information entered by the user comprises seek the relevant information entered by the user on a database including or not the relevant information prior to processed the relevant information.

4. The web-based search tool of claim 1, wherein inform one of the plurality of members comprises identify a member prior to inform one of the plurality of members.

5. The web-based search tool of claim 3, wherein the instructions causes the processor to further transmit relevant information sought or entered by the user to the informed member.

6. The web-based search tool of claim 1, wherein the plurality of members are professionally qualified to provide services according to the relevant information entered by the user.

7. The web-based search tool of claim 1, wherein each one of the plurality of members are registered in the member database.

8. The web-based search tool of claim 1, further comprising a geographical position locator for obtaining a geographical position of at least one of: one or or plurality of the plurality of members and the user.

9. The web-based search tool of claim 8, wherein each one of the plurality of members is being registered in the member database in association with a corresponding geographical position thereby defining a plurality of member geographical positions.

10. The web-based search tool of claim 9, wherein identify a member comprises identify a member based on the plurality of geographical positions of the plurality of members.

11. The web-based search tool of claim 1, wherein the plurality of members comprise lawyers, patent attorneys, accountants, publicists, engineers, trademark attorneys, professionals, law firms, accountant firms, trademark firms, patent firms, intellectual property firms, professional firms, engineering firms, estate agents and any combination thereof.

12. The web-based search tool of claim 8, wherein the geographical position locator is in communication with at least one of: a global positioning system, a position entry prompt and any suitable combination.

13. The web-based search tool of claim 8, wherein the geographical position comprises geographical coordinates, a country, a continent, a city, a street, a complete address, a state and any suitable combination.

14. The web-based search tool of claim 3, wherein the database comprises one of: a public database, a private database and any suitable combination.

15. The web-based search tool of claim 14, wherein the public database comprises a CIPO database, a USPTO database, an OHIM database, a WIPO database, a National Bureau of Patents and trademarks database and any suitable combination.

16. The web-based search tool of claim 1, wherein the relevant information comprises a trademark, invention patent, a company name and information, design data for industrial equipments, design data for structures or buildings and any suitable combination.

17. The web-based search tool of claim 1, wherein processing the relevant information comprises seeking the availability of a trademark, seeking the patentability of an invention, filing a trademark application, filing a patent application, seeking the availability for registration of a company, processing design data for industrial equipments, processing design data for structures or buildings and any suitable combination.

18. The web-based search tool of claim 1, wherein the member database further comprises information for each one of the plurality of members.

19. The web-based search tool of claim 18, wherein the information for each one of the plurality of members comprises a name, a first name, a firm or organization to which the member belongs, a logo of the firm or organization to which the member belongs, a personal photo, a biography, expertise information, areas of practice information, education information, an email address, a telephone number, an address of the firm to which the member belongs, a video of the firm or organization to which the member belongs and any suitable combination.

20. The web-based search tool of claim 10, wherein identify a member based on the geographical position of the member further comprises calculate distances between the geographical position of the user and each one of the geographical positions of the plurality of members and determine the smallest one of the distances and further wherein identify a member based on the geographical position of the member further comprises using the smallest one of the distances and identify which one of the plurality of members is closest to the geographical position of the user.

21-37. (canceled)
